(19) United States
(12) Patent Application Publication
(10) Pub. No.: US 2026/0038465 A1
(43) Pub. Date: Feb. 5, 2026

(54) Improved Saddle for Bridge for Electric Guitar

(71) Applicant: Allparts Music Corporation, Houston, TX (US)

(72) Inventors: Wesley Johnson, Pearland, TX (US); Dean Herman, Houston, TX (US); John Gordon, Missouri City, TX (US)

(73) Assignee: Allparts Music Corporation, Houston, TX (US)

(21) Appl. No.: 18/791,494

(22) Filed: Aug. 1, 2024

(51) Int. Cl. G10D 3/04

(52) U.S. Cl. CPC G10D 3/04

(57) ABSTRACT

A saddle for a bridge for an electric guitar comprises a front, a back, two sides, a bottom, a projection outward from a portion of the bottom and a two-part peak in which a first part of the peak comprises a string groove face rounded to support a guitar string and a back face angled away from the guitar string. The saddle has a height sized to improve intonation qualities of the saddle during use. The saddle further comprises a hooded intonation screw hole associated with the rounded string groove face and the back face to improve mounting of the intonation screw spring during use. The projection on the portion of the bottom of the saddle is sized to improve intonation.

### BACKGROUND OF THE INVENTION

Stringed instruments take a variety of forms and types, including violins, guitars, harps, banjos, pianos and others. Each type of stringed instrument operates on the premise of fixing a string of a certain length and thickness between two attachment points and applying tension to it to achieve a desired tone. Typically, one attachment point of a string is fixed while the other attachment point may be adjusted to change the frequency of the string for play. Tension is applied to the string to tune it to resonate at a desired frequency. Tension is commonly applied by turning a tuning key either to raise the frequency (tightening) or to lower the frequency (loosening).

In some instruments, such as harps and pianos, a large number of individual strings tuned to different specific frequencies are used. In others, such as guitars, violins and banjos, a smaller number of strings are used. The smaller number of strings in these types of instruments can provide a wide range of desires frequencies (as specific notes) when the player of the instrument manually shortens the playable part of a string. For example, on a guitar different frequencies are produced by a player by manually pressing a given string at a specific position against the fretboard of the instrument to shorten the length of the string during play, thereby raising the frequency of the string when played. In this way, many desired notes may be played.

A vibrating string in a musical instrument typically produces very little sound by itself. In most stringed instruments, the instrument is configured to comprise one or more components to receive the vibrations from a string and transfer that low volume sound into a means for amplifying the volume of the string vibration. Because this disclosure relates primarily to guitars, descriptions of guitar sound amplification are provided. Various other options exist for other types of stringed musical instruments but are not relevant here.

In an acoustic guitar, tensioned strings are positioned on a saddle which is positioned on a bridge. The bridge is positioned on a soundboard. The vibration from a played string causes the saddle to vibrate, which then causes the bridge and finally the soundboard to vibrate. The vibrations are amplified in the body of the guitar and exit through the sound hole in the soundboard. The body of the guitar resonates with the vibration of the string and amplifies the sound. The saddle, bridge and soundboard of an acoustic guitar are each made from materials which enhance and promote the transfer of the string vibration. These materials may include wood, plastic, metal or composite materials.

In an electric guitar, a pickup electronically receives sound from a string when played. Tensioned strings are positioned on one or more saddles. The one or more saddles are positioned on a bridge. The bridge is positioned on, around or over an electronic pickup. The pickup relays that sound to an amplifier, which processes the sound and sends it to the speakers used by the player. A bridge is commonly used on an electric guitar to maintain the strings in proper position relative to the pickup. In a known form of bridge, the bridge comprises a set of saddles to hold the strings of the guitar in place in proximity to a pickup. Vibrations from the strings are transferred to the saddles, then to the bridge and into the body of the guitar through the pickup. The pickup transfers string vibrations to the amplifier. More than one pickup may be used.

In each type of guitar, the bridge plays an important role in transferring vibrations from the string to the physical or electronic amplifying means of the guitar. The bridge can serve two, three or more functions. These functions may include retaining the strings in a desired position relative to the body of the instrument. That is, a bridge typically serves to hold each string in position at a certain height or distance above the face of the guitar and the pickup. At the same time, a bridge serves to separate each string from the next string. Likewise, a bridge acts as a resonance device to improve the pickup by the instrument of string vibration. Bridges may also serve to anchor strings used on the instrument.

Bridges can be made from a variety of materials, including wood, plastic (or resin), bone or metal. Bridges likewise can be made from a single component or be comprised of multiple components.

This disclosure concerns the design of a multi-component bridge made of a metal alloy. The invention disclosed herein extends from inventions and designs of Glen Quan, the developer of a series of electric guitar bridges known as the “Badass” family, including the Badass I, Badass II, Badass III, Badass V, Badass Wraparound and Badass Fine Tuner Tailpiece. Mr. Quan received U.S. Pat. No. 4,069,733, U.S. Pat. No. D2591195 and U.S. Pat. No. D5703995 for these variants. The original Badass bass bridges were designed to allow better contact of the grooves and saddles of the bridge to the bridge to improve the transfer of vibrations of the strings through the wooden body of the bass guitar. Mr. Quan used a dense zinc alloy that maximized tonal transfer to increase sustain, attack and note clarity.

The core function of the bridge of a guitar is to optimize the transfer of string vibrations to the pickups. Known bridges may fail to meet the needs of players based on one or more of a variety of characteristics such as shape, mounting and height of saddles as well as characteristics of the base of the bridge on which the saddles as mounted.

The present invention improves on the features of the original Badass bridges and meets other needs. The description of the invention and its embodiments in this disclosure is not limiting. The invention may be practiced in any suitable embodiment.

### SUMMARY OF THE INVENTION

The invention disclosed here is intended for use primarily with Telecaster® electric guitars, but use with other types of electric guitars is promoted and enabled. The invention is an improved bridge for an electric guitar, comprising a stepped plate made from a metal alloy, such as a zinc alloy, a plurality of saddles, mounting screws and mounting springs. The stepped plate may be referred to as the bridge “base.” A first step of the stepped plate has disposed therein an opening sized and shaped to fit around a pickup for an electric guitar (in particular, the Telecaster® guitar). A second step comprises a plurality of grooves, each of which is sized and shaped to retain a saddle in place by retaining a projection on the saddle in the groove. The second step further comprises a stepped cross-section to retain each saddle in position a pre-determined height above the face of the guitar. The cross-sectional steps of the second step hold the plurality of saddles on which strings of the guitar are disposed in a generally curved manner which matches the radius of curvature of the cross section of the fretboard of the guitar. If the bridge is used on a different brand of guitar, a shim of a pre-determined thickness may be inserted into one or more grooves to raise one or more saddles to a desired height to match the radius of curvature of the fretboard of the different brand of guitar.

A third step of the stepped plate comprises a thick wall further comprising holes to permit through-bridge or through-body mounting of the strings. Additional holes are provided for the insertion of intonation screws used to position a saddle in one of the plurality of saddle grooves disposed in the second step. A plurality of mounting holes for strings are disposed at the junction point between the second step and the third step of the stepped plate. These mounting holes comprise apertures shaped to limit and improve contact between each string and the stepped plate, in part to reduce string breakage by avoiding or minimizing the contact between the stepped plate and the string. Mounting holes permit through-body of through-bridge mounting of strings.

Each saddle used with the bridge comprises a shaped groove to retain a guitar string in place during use and a combined rounded and flattened profile to improve the transition of the string from the string mount to across the saddle. The rounded portion of the profile of each saddle is designed to minimize the contact between the saddle and the string. The flattened portion of the profile falls below contact with the string. The shaped groove in which the string is disposed is positioned on the rounded portion of the saddle and has a length which is minimized by the rounded profile of the saddle. A small horizontal surface is disposed between the rounded portion of the saddle and the flat portion of the saddle but is not part of the shaped groove. A threaded hole in the saddle to receive an intonation screw is offset from the midline of the saddle to keep the intonation screw clear from the string. Further, a protrusion on the saddle is disposed below the string groove. The protrusion has a length which is minimized to improve the transmission of vibrations of a string into the saddle on which it is disposed and further to improve the transmission of vibrations from each saddles into the stepped plate and then into the pickup. Each of the protrusion and the groove are offset from the midline of the saddle away from the threaded intonation screw hole.

In a preferred embodiment, two sizes of saddles are used. For many types of guitars, including electric guitars, two types of strings are used. Bass strings are commonly multi-component strings comprising an inner core having another component wound around the core. Treble strings are commonly a single string. Bass strings are typically thicker than treble strings. In the preferred embodiment, saddles used to retain bass strings in position have a wider groove to retain the thicker bass string. Saddles used to retain treble strings in position have a narrower groove to retain the narrower treble string. To improve the acoustical characteristics for each type of string, saddles used for bass strings (generally referred to as bass saddles) have a taller profile and a more pronounced rounded profile shape. Saddles used for treble strings (generally referred to as treble saddles) have a shorter profile and a less pronounced rounded profile shape. Otherwise, bass saddles and treble saddles have a substantially similar profile shape.

Other aspects of the bridge and saddles are described below.

### FIGURES

FIG. 1A depicts a top view of a known bridge.

FIG. 1B depicts an orthographic view of the known bridge of FIG. 1A.

FIG. 2 depicts an orthographic view of the invention from the direction of the fretboard including the stepped plate, bass saddles, treble saddles, intonation screws and intonation screw springs.

FIG. 3 depicts a top view of the stepped plate of the invention.

FIG. 4 depicts a cut away side view of the stepped plate of the invention.

FIG. 5 depicts a different orthographic view of the invention as in FIG. 1 from the direction of the string mounting holes of the invention.

FIG. 6 depicts a cross-sectional view of the second step of the stepped plate further depicting the steps of the saddle base and its radius of curvature. Bass saddles and treble saddles are depicted in place.

FIG. 7 depicts a detail of the stepped plate of the invention further depicting saddle grooves and mounting holes.

FIG. 8 depicts another view of a detail of the stepped plate of the invention further depicting saddle groove and string mounting holes.

FIG. 9 depicts a detail of the stepped plate of the invention further depicting recesses for string beads and intonation screw heads.

FIG. 10A depicts an orthographic view of a bass saddle of the invention.

FIG. 10B depicts an orthographic view of a treble saddle of the invention.

FIG. 11A depicts a front view of a bass saddle of the invention further depicting the protrusion, groove and intonation screw hole thereof.

FIG. 11B depicts a front view of a treble saddle of the invention further depicting the protrusion, groove and intonation screw hole thereof.

FIG. 12A depicts a top view of a bass saddle of the invention further depicting the groove of the bass saddle.

FIG. 12B depicts a top view of a treble saddle of the invention further depicting the groove of the treble saddle.

FIG. 13 depicts a side view of an intonation screw used with the invention.

FIG. 14 depicts a side view of an intonation screw spring used with the invention.

FIG. 15 depicts a plurality of bass saddles and treble saddles each associated with a groove and using a shim to raise the height of four of the saddles relative to the stepped plate.

FIG. 16 depicts a representative shim.

FIG. 17 depicts a cut away side view of the stepped plate, bass saddle and guitar string, with guitar string passing through a through body mounting hole.

### DETAILED DESCRIPTION OF THE INVENTION

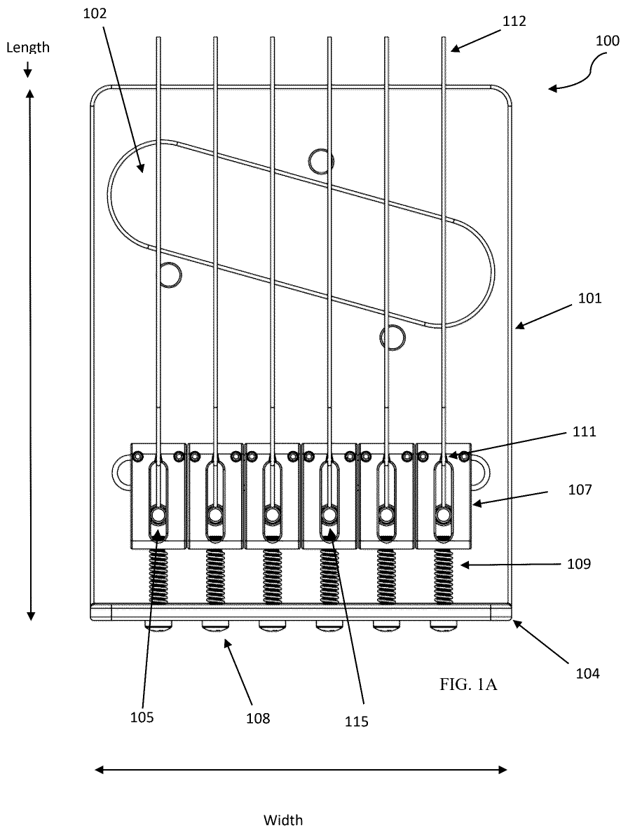

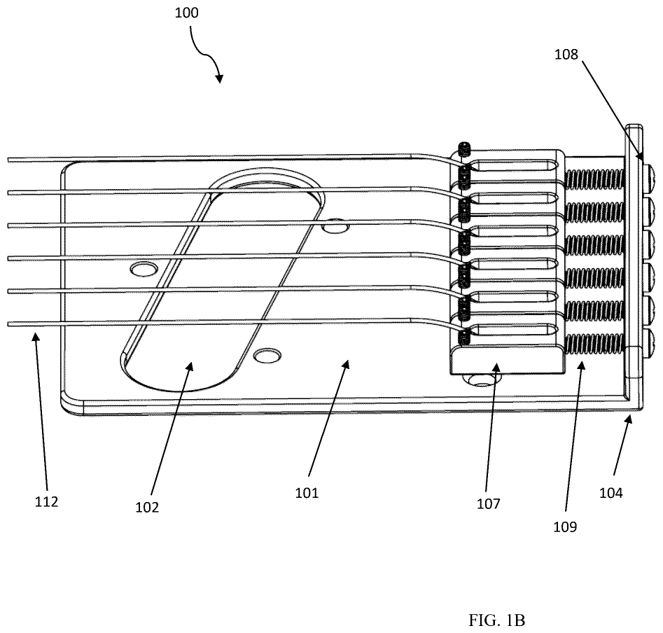

Referring first to FIG. 1A and FIG. 1B, a top view and an orthographic view of a bridge 100 known in the art are shown. FIG. 1A and FIG. 1B depict an earlier version of the Badass bridge from which the present invention was developed. Therein, a generally flat plate 101 comprises a hole 102 cut into flat plate 101 to accommodate a pickup (not depicted) commonly used in the industry. As depicted in FIG. 1A, flat plate 101 has a length and a width as those terms are commonly used. Flat plate 101 further comprises a mounting end 104 in which are disposed a plurality of through-bridge mounting holes (not depicted) and through-body mounting holes 105. Mounting end 104, as depicted more clearly in FIG. 1B, is generally described as a rigid part of bridge 100 projecting at a right angle outward from the guitar on which bridge 100 is mounted. Flat plate 101 has a thickness which remains constant across the entirety of flat plate 101. Mounting end 104 has a thickness which is approximately the same thickness as flat plate 101. Although not specifically depicted in either FIG. 1A or FIG. 1B, mounting end 104 has a height which remains constant across the width of flat plate 101. The known bridge further comprises a plurality of saddles 107, intonation screws 108 and intonation screw springs 109. Flat plate 101 may be made from any suitable material, including a metal, a metal alloy or plastic. Similarly, saddles 107 may be made from a suitable substance. Intonation screws 108 and intonation screw springs 109 are typically made from a suitable metal. Edges of flat plate 101 may be beveled for ease of handling.

A guitar string 112 may be mounted in each of the through-bridge mounting holes or, as depicted in FIG. 1B, in each of the through-body mounting holes 105. Each string 112 is then strung across a string groove 111 cut into each saddle 107. Each saddle 107 has disposed therein an elongated cut-out 115 through which string 112 passes from through-body mounting hole 105 and across groove 111.

The limits of known bridge 100 are evident. Because bridge 100 is flat across its width, each saddle 107 sits at the same level for playing as each other saddle 107. As a result, each string 112 sits at the same playing level as each other string 112. Mounting holes are designed in a way which imposes a very small surface of contact between a string 112 and each type of mounting hole. The very small contact surface at the mounting hole and the very small contact surface on saddle 107 in groove 111 create stress points on strings 112, which may increase the likelihood of string breakage during play. Likewise, the uniform thickness of flat plate 101 of bridge 100 results in a single level of string heights at the bridge end of the strings even if the fretboard (not depicted) is rounded cross-sectionally. Playing a set of strings of the same height above the bridge of the guitar can be more difficult.

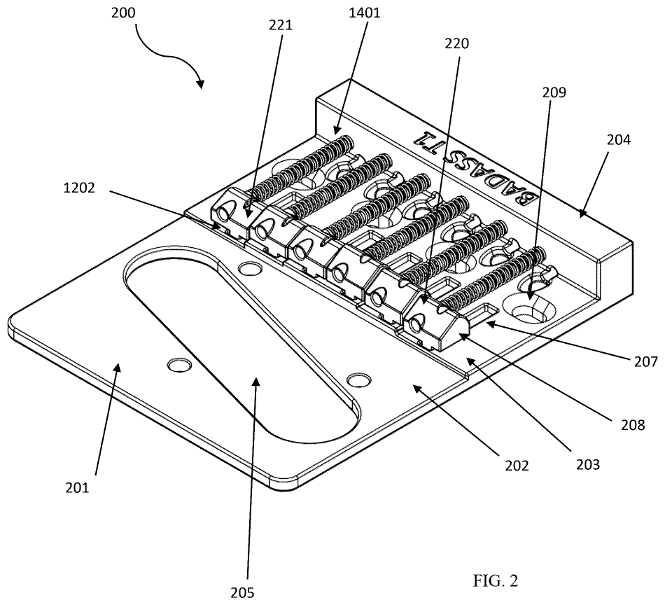

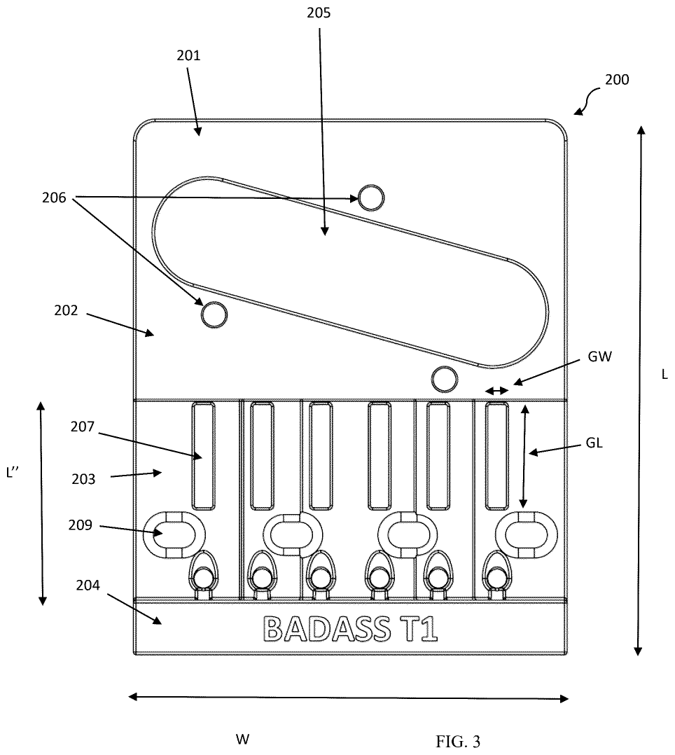

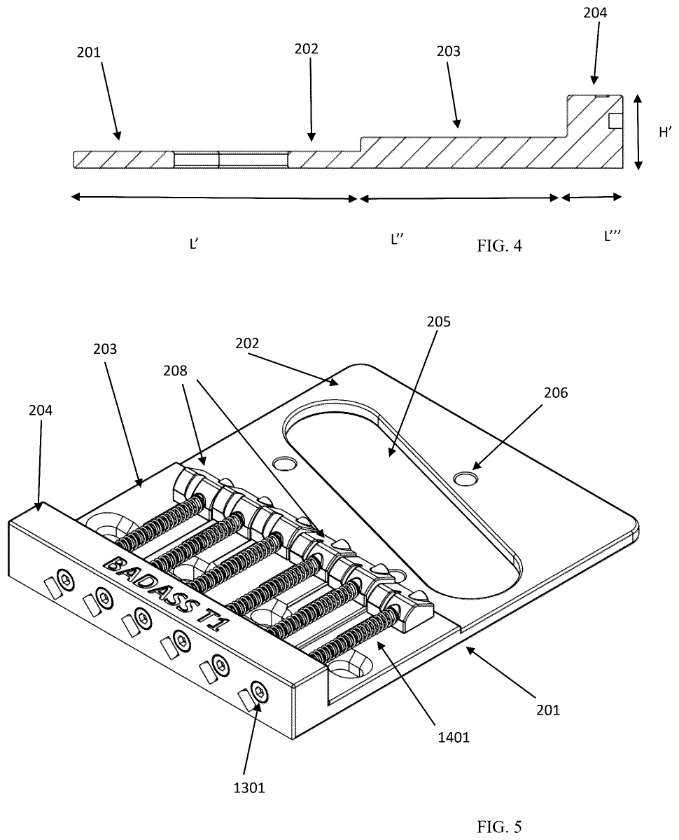

Referring now to FIG. 2, FIG. 3 and FIG. 4 together, invention 200 comprises a stepped plate 201 made from a suitable metal alloy, such as a zinc alloy, with desirable acoustic qualities. As with known bridge 100, various parts of invention 200 may comprise beveled edges. Beveling is not described in detail herein because it is not generally relevant to the inventive aspects of invention 200. Stepped plate 201 has a length L and a width W, as depicted in FIG. 3. Referring also to FIG. 2 and FIG. 4, stepped plate 201 comprises a first step 202, which has a length L′. Length L′ is approximately ½ the length L. First step 202 has disposed in it a pickup hole 205 positioned to accommodate the pickup of most electric guitars. Also disposed on first step 202 is a plurality of screw holes 206 to allow the invention 200 to be secured to a guitar. As seen in FIG. 2, first step 202 has a uniform thickness across the width W of the invention 200.

Still referring to FIG. 2, FIG. 3 and FIG. 4, stepped plate 201 comprises a second step 203. Second step 203 has a length L″ and has disposed therein a plurality of grooves 207. The number of grooves 207 is typically the same as the number of strings to be mounted on the guitar. Six grooves 207 are depicted here. As depicted in FIG. 2, one groove 207 is used to position one saddle 208 by the insertion of a projection 1202 on saddle 208 into groove 207, as described in more detail below. Two types of saddles 208 are described herein: bass saddle 220 and treble saddle 221. In this disclosure, when the difference between bass saddles 220 and treble saddle 221 is not significant in the description, reference may be made to saddles 208 generally. Otherwise, reference will be made to the specific form of bass saddle 220 or treble saddle 221, as applicable. Also disposed in second step 203 is a plurality of slotted holes 209 devised to allow screws (not depicted) to removeably attach the invention 200 to the body of an electric guitar for use. Slotted holes 209 allow some variation in the positioning and orientation of invention 200. Referring in addition to FIG. 6, second step 203 and bass saddles 220 and treble saddles 221 are depicted in a cut-away view.

Referring still to FIG. 6, it is seen that second step 203 comprises a stepped cross-section 601. As shown in FIG. 6, a representative six grooves 207 are disposed in second step 203 of stepped plate 201. Grooves 207 are described below in more detail. Six saddles 208 are numbered 1 through 6 for convenience here, although saddles 208 numbered 1 through 3 are likewise bass saddles 220 and saddles 208 numbered 4 through 6 are likewise treble saddles 221. (For clarity, “dashed” arrows are used for the secondary numbering of 1 through 6 of saddles 208.) Stepped plate 201 has a bottom 602. It is seen that three levels of steps are created by the stepped cross-section 601 of second step 203. That is, saddles 208 numbered 1 and 6 are set a first height over bottom 602. Saddles 208 numbers 2 and 5 are set a second height over bottom 602. Saddles 208 numbered 3 and 4 are set a third height over bottom 602. The first height is the lowest step height. The second height is higher than the first height, and the third height is higher than the second height. If an imaginary arc were imposed over the cross-section of second step 203, the imaginary arc would be seen to describe a portion of a circle having constant radius across the width W of stepped plate 201. The radius of curvature described for the cross-section of second step 203 is 9.5 inches. This is the same radius of curvature as the cross-sectional radius of curvature of the fretboard of the standard Telecaster electric guitar, not depicted. In other embodiments, a different radius could be imposed across second step 203 to match the radius of curvature of a different guitar fretboard. Generally, it is a purpose of the invention to create a stepped cross section 601 on second step 203 having the same radius of curvature as the fretboard of the guitar on which invention 200 is placed for use.

FIG. 2, FIG. 3, FIG. 4, FIG. 5 and FIG. 6 further depict third step 204 of stepped plate 201. Third step 204 has a design common in bridges. As best depicted in FIG. 4, third step 204 has a length L′″ and a height H′ suitable to provide a resilient structure for mounting guitar strings under tension thereon. As depicted in FIG. 2, FIG, 4 and FIG. 5, third step 204 may be described as projecting at a right angle up and outward from the body of the guitar on which invention 200 is mounted. Third step 204 must be sufficiently robust to perform its intended function of retaining a plurality of guitar strings under constant tension to maintain tone of each string during potentially robust use by a guitar player. Unlike mounting end 104 of known bridge 100, which has a thickness approximately the same as the thickness of flat plate 101, third step 204 has a thickness, referred to as length L′″, much thicker than the thickness of either first step 202 or second step 203 of stepped plate 201.

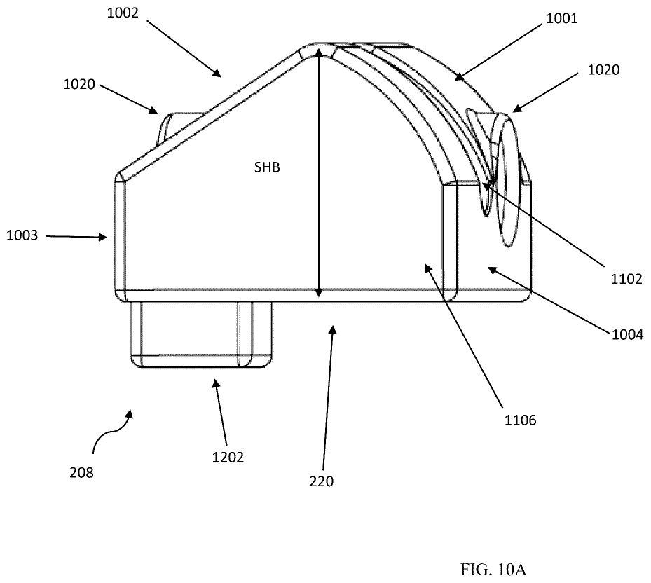

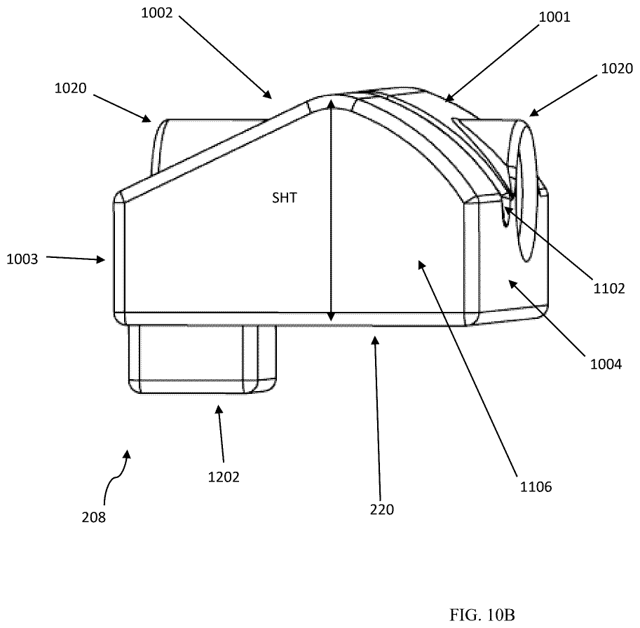

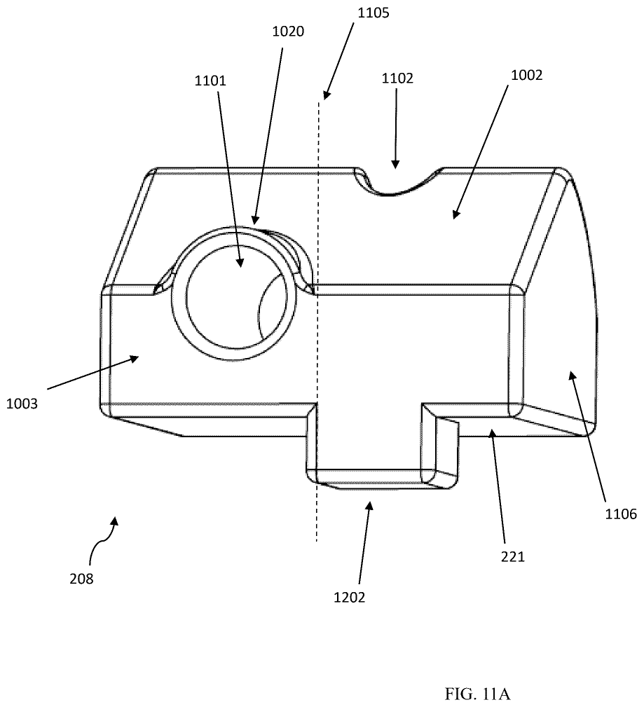

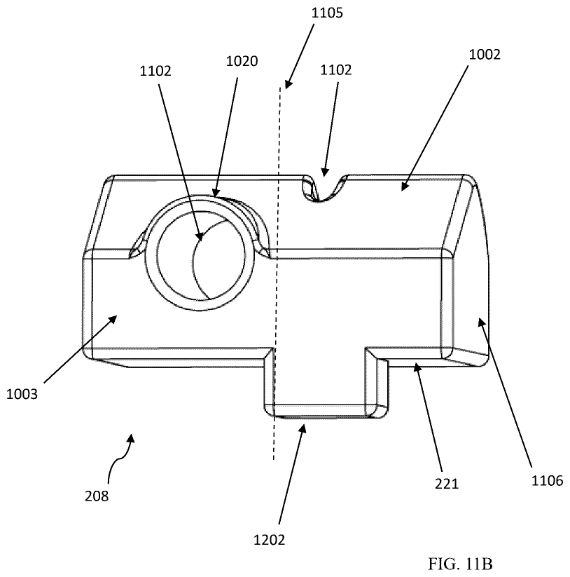

Referring now to FIG. 10A, FIG. 10B, FIG. 11A, FIG. 11B, FIG. 12A and FIG. 12B, the two versions of saddle 208 are depicted as bass saddles 220 (FIG. 10A, FIG. 11A and FIG. 12A) and treble saddle 221 (FIG. 10B, FIG. 11B and FIG. 12B). Although a single design of saddles is commonly used in bridges, bass strings and treble strings typically have a different design. Bass strings typically have a thicker diameter and are commonly comprised of an outer layer of material wrapped around a central filament. Treble strings are typically thinner than bass strings and are commonly comprised of a single material. Because of these differences and the frequencies at which each type of string plays, bass strings and treble strings have different intonation qualities. It is useful to use saddles having intonation qualities relative to the distinct intonation qualities of the strings.

These distinct intonation qualities of the different guitar strings may be accounted for by the use of two types of saddles with invention 200: bass saddle 220 and treble saddle 221. Each of bass saddle 220 and treble saddle 221 is comprised of the same metal alloy or a similar metal alloy as stepped plate 201. Each of bass saddle 220 and treble saddle 221 comprises a rounded string contact face 1001 which, during use, is positioned in the direction of third step 204 on stepped plate 201. In the direction of bass saddle 220 and treble saddle 221 away from third step 204, each of bass saddle 220 and treble saddle 221 comprises a back face 1002. Back face 1002 is designed to avoid contact between either bass saddle 220 or treble saddle 221 and the string associated with that saddle.

As best depicted in FIG. 12A and FIG. 12B, bass saddle 220 and treble saddle 221 further comprise a string groove 1102 disposed across the entirety of string contact face 1001 of each type of saddle. String groove 1102 has a width sized to accommodate the type of guitar string used therein. String groove 1102 of bass saddle 220 is wider to accommodate a woven bass string while string groove 1102 of treble saddle 221 is narrower to accommodate the single component treble string used in treble saddle 221.

Still referring to FIG. 10A, FIG. 10B, FIG. 11A and FIG. 11B, each of bass saddle 220 and treble saddle 221 further comprises a back 1003 and a front 1004.

As best depicted in FIG. 10A and FIG. 10B together, bass saddle 220 has a saddle height bass SHB which is larger than the saddle height treble SHT of treble saddle 221. Referring also to FIG. 12A and FIG. 12B, bass saddle 220 and treble saddle 221 each have a width and depth as shown. The width and depth of bass saddle 220 and treble saddle 221 are identical. The height difference between the two types of saddles is enabled to ensure desired intonation of the strings which are mounted across each type of saddle. Bass saddle height SHB and treble saddle height SHT are each determined, in a proprietary process not disclosed herein, to optimize the quality of the sound produced by the different types of strings used on a guitar.

Referring to FIG. 12A and FIG. 12B, imaginary center line 1105 (depicted as a dashed line) is disposed to bisect the width of each of bass saddle 220 and treble saddle 221. Center line 1105 identifies the position of string groove 1102 on string contact face 1001. With each bass saddle 220 and treble saddle 221 positioned with the string contact face 1001 of each toward the top of the page, each string groove 1102 is depicted entirely to the right of the center line 1105. As depicted in FIG. 11A and FIG. 11B, a threaded intonation screw hole 1101 is disposed entirely to the left of center line 1105 (from the same perspective). (Intonation screw hole 1101 is not depicted as threaded in the figures.) Still also referring to FIG. 11A and FIG. 11B, along with FIG. 12A and FIG. 12B, intonation screw hole 1101 is drilled through each of bass saddle 220 and treble saddle 221 with a portion of it disposed from front 1004 to back 1003 and a portion disposed from string contact face 1001 to back face 1002. Intonation screw hole 1101 is oriented in each of bass saddle 220 and treble saddle 221 to align with the associated intonation screw mounts 901 disposed in third step 204, as described in more detail below. An integral hood 1020 is associated with each of string contact face 1001 and back face 1002 relative to intonation screw hole 1101 to provide additional stability to intonation screw hole 1101 during use. As depicted, hood 1020 comprises an extension on each of string contact face 1001 and back face 1002 to permit intonation screw hole 1101 to extend on each of bass saddle 220 and treble saddle 221 to each of front 1004 and back 1003 as shown. In this way, hood 1020 on each of string contact face 1001 and back face 1002 result in intonation screw hole 1101 having the shape of a right cylinder. This shape of the hood 1020 on the string contact face 1001 provides support for the intonation screw spring 1401 when used to mount a saddle 208 using an intonation screw 1302 as described below. Bass saddle 220 and treble saddle 221 each have two flat sides 1106 which, during use and as depicted in FIG. 6, abut at least one other saddle 208 side 1106.

Still referring to FIG. 10A, FIG. 10B, FIG. 11A and FIG. 11B, a protrusion 1202 extends downward (from the perspective of the groove 1102 being disposed on the “top” of each of bass saddle 220 and treble saddle 221) from each of bass saddle 220 and treble saddle 221. With imaginary center line 1105 depicted in FIG. 11A and FIG. 11B, it is shown that protrusion 1202 is positioned nearly entirely to one side of center line 1105 directly under string groove 1102 of each saddle. As depicted in FIG. 10A, FIG. 10B, FIG. 11A and FIG. 11B, protrusion 1202 extends integrally on each of bass saddle 220 and treble saddle 221 starting from back 1003 approximately ⅓^{rd} of the bottom 1210 of each of bass saddle 220 and treble saddle 221 in the direction of front 1004. In known embodiments of saddles, such protrusions extended along the entire bottom of the saddle 208. Intonation of the guitar is improved, however, by shortening the length of the protrusion 1202 as described.

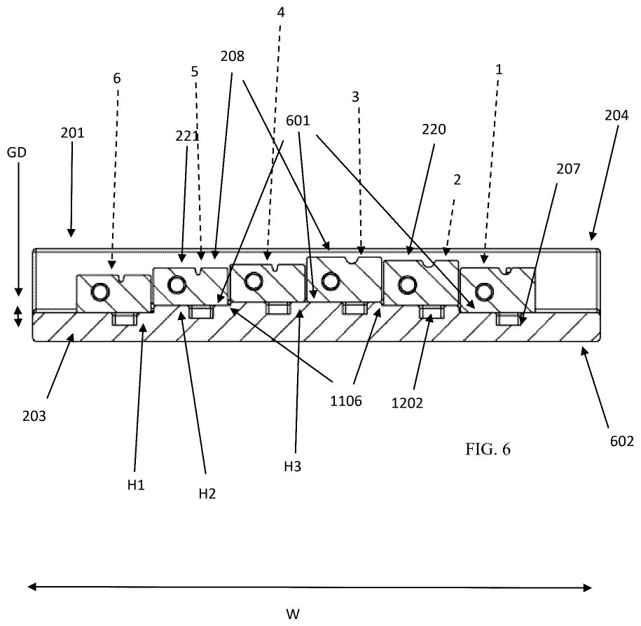

Referring also to FIG. 3, FIG. 6 and FIG. 7, each groove 207 in second step 203 of stepped plate 201 has a groove width GW (see FIG. 3) and groove depth GD (see FIG. 6). Protrusion 1202 is sized to fit slidably and functionally in groove 207. For clarity, protrusion 1202 of bass saddle 220 and treble saddle 221 is disposed in groove 207, permitting one saddle 220 or 221 to be slidably positioned in a desired position (relative to intonation preferences) in groove 207.

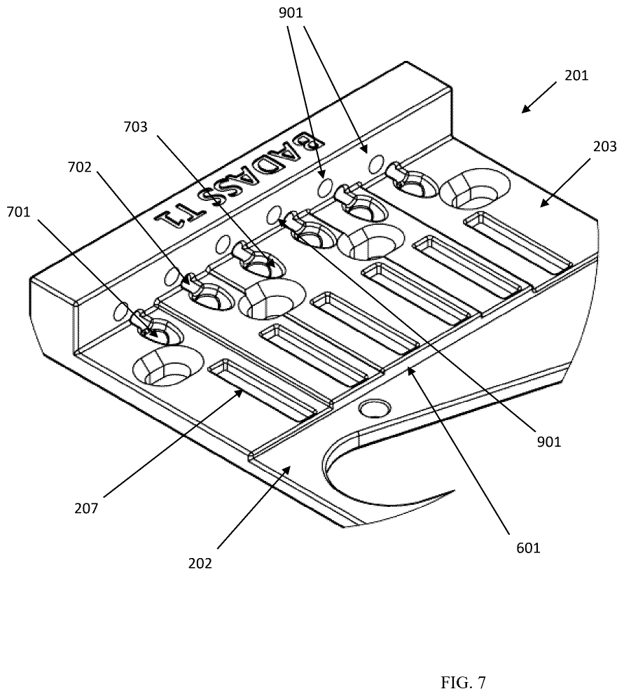

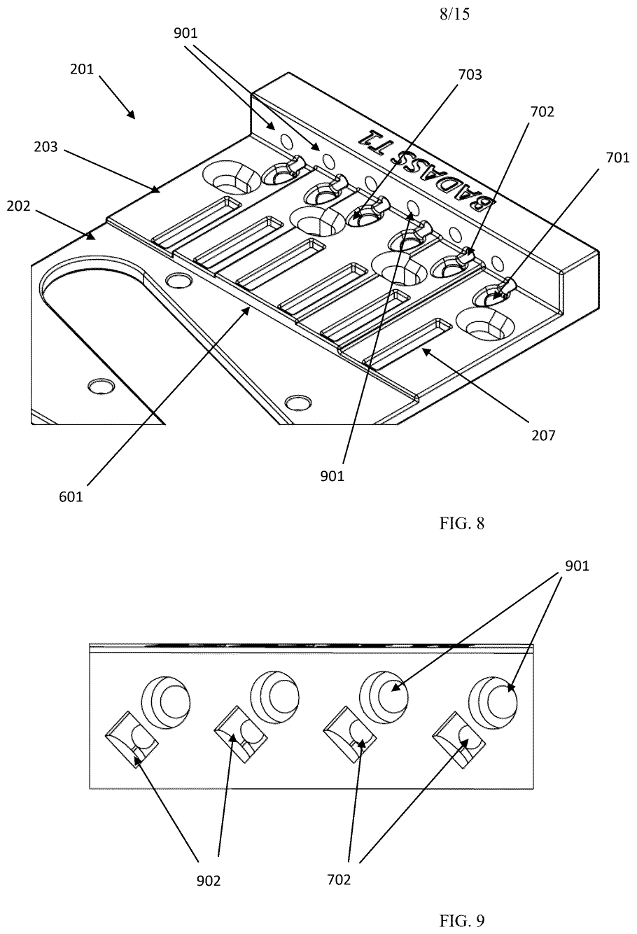

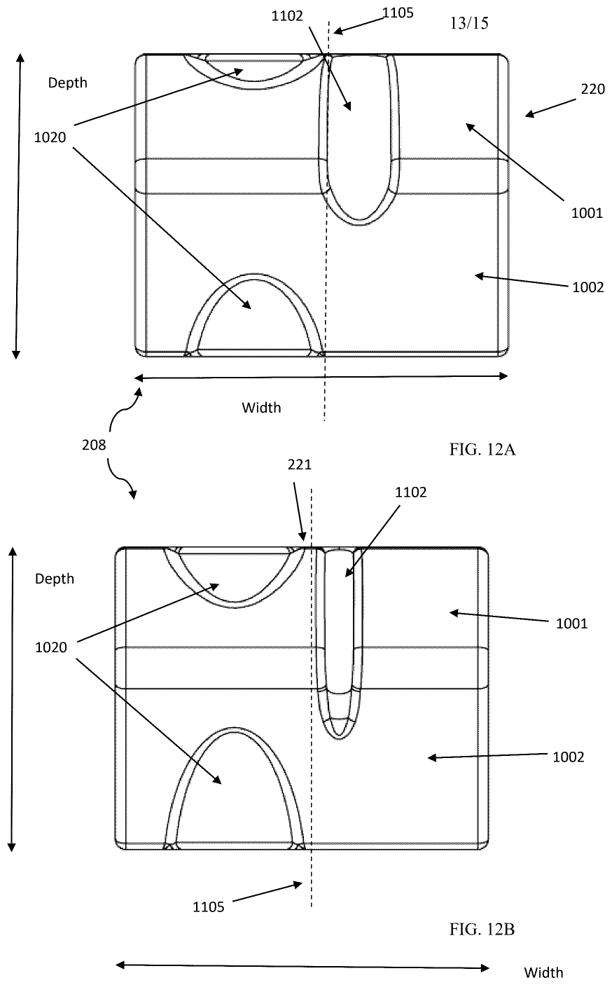

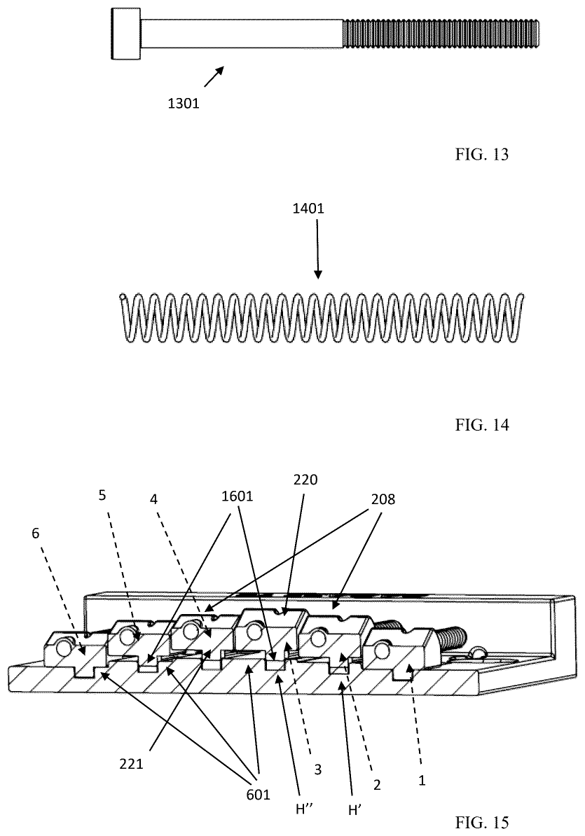

Referring to FIG. 3, with reference to FIG. 6, FIG. 7 and FIG. 8, groove 207 has a groove length GL approximately one half the length L″ of second step 203. Groove 207 is disposed in second step 203 proximal to a transition from first step 202 to second step 203. Referring also to FIG. 2, along with FIG. 5, FIG. 6, and FIG. 8, one bass saddle 220 or treble saddle 221 protrusion 1202 is disposed in each groove 207. One intonation screw 1301 (FIG. 13) and intonation screw spring 1401 (FIG. 14) are used to retain each of either bass saddle 220 or treble saddle 221 in position. When assembled, by adjusting intonation screw 1301 in intonation screw hole 1101 of either bass saddle 220 or treble saddle 221, as applicable, the position of that saddle 208 in groove 207 may be adjusted to optimize intonation of the associated guitar string. For this, referring to FIG. 8 and FIG. 9, a plurality of recessed intonation screw mounts 901 are disposed in the third step 204 of the stepped plate 201. One intonation screw mount 901 is associated with one groove 207. One intonation screw hole 901 is provided for each of either bass saddle 220 or treble saddle 221, along with one intonation screw spring 1401. One intonation screw 1301 is inserted into and through an intonation screw mount 901. An intonation screw spring b is placed over the threads of the intonation screw 1301. Threads of the intonation screw 1301 are then threaded into the threaded intonation screw hole 1101 of either bass saddle 220 or treble saddle 221, as applicable, which is positioned in a groove 207. This is repeated for each saddle 208. FIG. 2 and FIG. 5 depict different orthographic views of the invention 200 with a plurality of intonation screws 1301, intonation screw springs 1401 and saddles 208 (three each of bass saddles 220 and treble saddles 221) assembled on a stepped plate 201. As depicted in FIG. 7, FIG. 8 and FIG. 9, second step 203 has a constant radius of curvature along its length L″. As a result, through-bridge string holes 702, through-body string holes 701 and shaped apertures 703 are disposed across second step 203 and are disposed in third step 204 in the same radius of curvature as grooves 207. Similarly, intonation screw mounts 901 in third step 204 are disposed in the same radius of curvature as imposed across the width of second step 203. This facilitates the insertion of an intonation screw 1301 through an intonation screw mount 901 and into an intonation screw hole 1101 of a saddle 208.

Referring again to FIG. 6, six saddles 208 (three bass saddles 220 and three treble saddles 221) are depicted in position on second step 203 of stepped plate 201. As previously noted, saddles 208 further numbered 1 through 3 are treble saddles 221 and saddles 208 numbered 4 through 6 are bass saddles 220. For convenience as to this paragraph, all 6 saddles are referred to simply as saddles 208. Referring also to FIG. 10A and FIG. 10B, for adjoining saddles 208, each has at least one side 1106 placed in contact with a side 1106 of the saddle 208 disposed in one or two proximately positioned groove 207. Saddles 208 numbered 2 through 5 each has two sides 1106 in contact with two other saddle 208 sides 1106. With this, the stepped cross-sectional shape of second step 203 of stepped plate 201 is also depicted. Saddles 208, previously numbered individually 1 through 6, are shown in three steps (1 and 6, 2 and 5, 3 and 4) creating a stepped, arched or curved base for the plurality of strings (not depicted here) of the guitar. Because bass saddles 220 have a bass saddle height SHB taller than the treble saddle height SHT of treble saddles 221, grooves 1102 disposed in base saddles 220 retain strings (not depicted) slightly higher than grooves 1102 in treble saddles 221.

Referring now to FIG. 7, FIG. 8 and FIG. 17, each groove 207 is associated with a combined through-body string hole 701 and through-bridge string hole 702. Each of through-body string hole 701 and through-bridge string hole 702 comprise a mounting end (depicted as mounting end 902 in FIG. 9 and mounting end 1705 in FIG. 17) which is recessed to permit the insertion of a string bead (not depicted in FIG. 9 and depicted as string bead 1710 in FIG. 17) commonly disposed on guitar strings. Each of through-body string hole 701 and through-bridge string hole 702 is associated with a shaped aperture 703. Shaped aperture 703 is approximately the shape of a half ovoid. Toward the third step 204 direction of shaped aperture 703, through-bridge string hole 702 is disposed in a fluid connection with shaped aperture 703. Through-body string hole 701 is disposed within shaped aperture 703 so as to allow a fluid connection through the second step 203 of stepped plate 201.

Still referring to FIG. 7 and also FIG. 17, shaped aperture 703 is disposed in second step 203 of the stepped plate 201 such that the transition from the second step 203 into shaped aperture 703 is rounded to smooth any contact between a guitar string 1701 and shaped aperture 703. This reduces wear and tear on string 1701. Referring to FIG. 17, a cut-away side view of stepped plate 201 showing shaped aperture 703, through-body string hole 701 and saddle 208 is depicted. Also depicted is string 1701. As shown in FIG. 17, string 1701 extends through through-body string hole 701 into shaped aperture 703 and makes contact with the rounded transition from the shaped aperture 703 to the second step 203. String 1701 is retained in position in mounting end 1705 using string bead 1710. The rounded transition reduces stress and abrasion at the contact point. String 1701 then extends through groove 1102 of representative saddle 208. Groove 1102 on saddle 208 likewise reduces stress and abrasion between string 1701 and groove 1102 of saddle 208. Stepped plate 201 elements, including the pluralities of shaped apertures 703, through-bridge holes 702 and through-body holes 701 are depicted in a different perspective in FIG. 8.

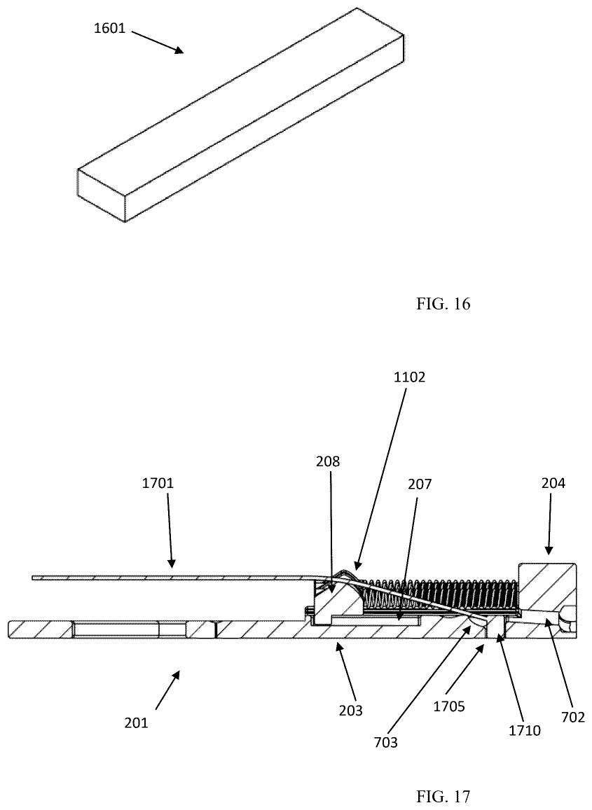

Referring now to FIG. 15 and FIG. 16, and likewise to the discussion above of the radius of curvature created by the stepped cross section 601 of second step 203 of stepped plate 201, as depicted in FIG. 6, invention 200 may be modified to change radius of curvature of stepped cross section 601 as to saddles 208 disposed in grooves 207 by the use of shims 1601 used in conjunction with one or more saddles 208. As depicted in FIG. 6, stepped cross section 601 of second step 203 creates steps which rise to a first, second and third height above bottom 602. In the absence of any shims 1601, the height at which each saddle 208 sits reflects the radius of curvature previously described. In some uses of the invention, setting one or more of saddles 208 and thus the strings of the guitar set on each groove 1102 to the cross-sectional radius of curvature in second step 203 is not desired. Shim 1601 has a length approximately the same as groove length GL and a width approximately the same as groove width GW of groove 207, although slightly smaller in order to fit workably into groove 207. Shim 1601 has a height set at one of H′, H″, H′″ or otherwise, in which the “prime” accent refers to a shim height calculated to be used with other shims 1601 or no shims relative to other saddles 208 used on a stepped plate 201 to a desired radius of curvature of saddle 208 heights other than the radius of curvature built into second step 203. As depicted in FIG. 15, shims 1601 having a height H′ are placed in grooves 207 associated with saddles 208 previously numbered 2 and 5. Likewise, shims 1601 having a height H″ are placed in grooves 207 associated with saddles 208 previously numbered 3 and 4. No shims 1601 are used with saddles 208 previously numbered 1 and 6. As depicted in FIG. 15, by using shims 1601 having heights H′ and H″ produce a radius of curvature of the saddles 208 different from the radius f curvature built into second step 203. Shims 1601 may be used to create a variety of radii of curvature or no curvature (flat strings from a cross-sectional perspective).

A variation of the heights of saddles 208 in FIG. 15 is preferred. As depicted in FIG. 15 and as previously described, bass saddles 220 are slightly taller than treble saddles 221. This height difference may be maintained through the use of shims 1601. This is depicted in FIG. 15. In some embodiments, it may be desired to use and place shims 1601 having heights H′, H″, H′″ and H″″ sufficient to offset the height different between bass saddles 220 and treble saddles 221. In practice, shims 1601 may be used by a player to suit the string position preferences of the player, including changing string height from time-to-time.

The invention 200 is designed to ensure high tonal quality when used with different guitars. The metal alloy from which the stepped plate 201 and saddles 208 are made is intended to be highly suited for use to make guitar bridges and this is enabled further by the design of the shaped apertures 703 of stepped plate 201 and groove 1102 on each type of saddle 208. Further, the length and position of the protrusion 1202 on each saddle 208 enables high quality vibration transfer to the pickup while likewise allowing a player broad choice in setting string heights through the use of shims 1601. The features of the invention 200 thereby promote both sound quality and ease of playing the electric guitar on which the invention 200 is used.

We claim:

1. A saddle for use with the bridge of an electric guitar comprising:
a generally rectangular solid further comprising a peaked projection in which the generally rectangular solid and peaked projection comprise a height, a width and a depth and further comprising;
a front;
a back;
a bottom;
two sides;
a protrusion extending from the bottom suitable to be retained in a guitar saddle groove of a bridge for an electric guitar;
a rounded guitar string contact face comprising a first part of the peaked projection;
a back face comprising a second part of the peaked projection;
a threaded intonation screw hole further comprising two hood components associated with one hood component associated with each of the rounded guitar string contact face and the back face; and
a guitar string groove.

2. The saddle of claim 1 in which the guitar string groove has a width in which the width is determined based on the type of guitar string used on the electric guitar.

3. The saddle of claim 2 in which the width of the guitar string groove is sized for use with a bass guitar string.

4. The saddle of claim 2 in which the width of the guitar string groove is sized for use with a treble guitar string.

5. The saddle of claim 1 in which the height of the saddle from the bottom of the saddle to the peaked projection is determined by the type of string used with the saddle.

6. The saddle of claim 5 in which the height of the saddle when used with a bass string is larger than the height of the saddle when used with a treble string.

7. The saddle of claim 1 in which the protrusion on the bottom of the saddle extends on the bottom from the back of the saddle to approximately one third the distance from the back to the front of the saddle.

8. The saddle of claim 7 in which the protrusion and the guitar string groove are disposed on the saddle to one side of a center line bisecting the saddle vertically.

9. The saddle of claim 8 in which the threaded intonation screw hole is disposed to the other side of a center line bisecting the saddle vertically.

10. The saddle of claim 1 in which the hood associated with each of the rounded string contact face and the back face enable for the threaded intonation screw hole the shape of a right cylinder.

11. The saddle of claim 5 in which the height of the saddle is determined by the intonation qualities of the strings used on the saddle.
